(19) United States
(12) Patent Application Publication
(10) Pub. No.: US 2026/0336902 A1
(43) Pub. Date: Oct. 29, 2026

(54) A SOLID CELLULOSE FOAM PRODUCT FOR PROTECTION OF AN OBJECT

(71) Applicant: Stora Enso OYJ, Helsinki (FI)

(72) Inventors: Liga Viksne, Jelgavas novads (LV); Kristine Biteniece, Riga (LV)

(73) Assignee: Stora Enso OYJ, Helsinki (FI)

(21) Appl. No.: 19/112,443

(22) PCT Filed: Sep. 22, 2023
(86) PCT No.: PCT/IB2023/059380

§ 371 Date: Mar. 17, 2025

(30) Foreign Application Priority Data
Sep. 23, 2022 (SE) 2230305-1

(51) Int. Cl. B65D 81/05; D21J 1/02; D21J 1/04; D21J 1/16

(52) U.S. Cl. CPC B65D 81/057; D21J 1/02; D21J 1/04; D21J 1/16; B65D 2581/053; B65D 2581/058

(57) ABSTRACT

The invention relates to a solid cellulose foam product for protection of an object, said solid cellulose foam product comprising at least one base portion comprising at least one hole and at least one housing; said at least one housing of said at least one base portion is arranged to house a protruding portion of said object; and at least one plug arranged in said at least one hole of said at least one base portion. The invention further relates to a method of producing said solid cellulose foam product.

### FIELD OF THE INVENTION

The present invention relates to the area of cellulose foam materials for packaging, more specifically to a solid cellulose foam product for protection of an object. The invention further relates to a method of producing a solid cellulose foam product.

### BACKGROUND INFORMATION

Plastic packaging materials such as fossil-based foams seem increasingly outdated in a society that is striving to reduce plastic usage and waste and move towards renewable materials. With regulatory bodies now driving policy towards limiting or banning fossil-based foam materials in packaging, new solutions are needed.

There are many challenges with finding foam materials from renewable sources. Many bio-based foams have higher cost of production and lower mechanical performance, as well as poor stability in water or high temperatures, compared to established foams from oil-based sources. Bio-based and recyclable protective materials need to have the same excellent characteristics and properties as petroleum-based protective materials for being the first choice over petroleum-based materials.

Low weight and good shock absorption of the bio-based foams are examples of crucial characteristics. Also, the ability to customize the shape and the form of the bio-based foams to the shape and form of the goods to be sheltered by the protective material is of uttermost importance.

The goods to be sheltered may very often have protruding portions, such as corners and/or edges, that need extra protection by the packaging material during storage and transportation. In addition, the goods may be made of highly fragile materials, such as glass or porcelain, that need protection because of their fragile nature. The bio-based foams on the market do not provide the necessary protection when the foam receives constant corner or edge shock during the delivery cycle.

Several biobased foams comprising cellulose have been described. WO20200011587 A1 describes a porous material that is prepared by aerating a paste comprising cellulose fibres and gluten and depositing the aerated paste in a mould where it is dried.

WO2015036659 A1 describes a moulded fibrous product prepared by foaming an aqueous suspension of natural fibres in combination with synthetic fibres and surfactant, feeding the fibrous foam to a mould where it is dried to produce a dry fibrous product. However, there still exists a need for solid cellulose foams that can be tailored around sensitive products of any shape and protect every part of the product. Any protruding part, e.g. corners or edges of the product, has to be so well sheltered so that any shock arising during storage and transportation will be absorbed by the surrounding cellulose foam and whereby the shock will not damage the protruding part.

Also, the solid cellulose foams need to be renewable, biodegradable, and fully recyclable in regular paper and board flows allowing them to be part of a circular material flow in existing packaging waste management systems. Production costs of producing the foams as well as tailoring their shapes to any product shape have to be moderate in order to be a competitive choice.

### SUMMARY OF THE INVENTION

It is an object of the present invention to obviate at least some of the disadvantages in the prior art by providing a solid cellulose foam product for protection of an object according to claim 1.

Thanks to a solution as defined in claim 1 protruding portions of an object will be very well protected from shock and vibrations during storage and transportation. The protruding portion, such as a corner, of the object will be kept in place by the housing in the base portion of the solid cellulose foam product. The cushioning properties of the solid cellulose foam product will also protect the protruding portion. The presence of plug(s) will lead to improved protection properties of the solid cellulose foam product.

Another advantage is that the waste of cellulose material is reduced or even eliminated which reduces production costs and saves raw material.

Compared to known methods the present process is easy to perform in a large scale set up.

Further aspects and embodiments are defined in the appended claims, which are specifically incorporated herein by reference.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exploded view of a preferred embodiment of a solid cellulose foam product;

FIG. 2 is an oblique side-view showing the preferred embodiment of FIG. 1 with assembled components of the product;

FIG. 3 is an oblique view from above showing the preferred embodiment of FIG. 1 with assembled parts, and

FIG. 4 shows an object having its protruding parts protected by the inventive solid cellulose foam product of a second preferred embodiment.

### DETAILED AND EXEMPLIFYING DESCRIPTION OF THE INVENTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

The expression “flat object” as used herein means an object having a height, a width and a length. Said width and length defining two surfaces and said height defining at least one side wall. Said height is so small in relation to said length and width that said object is related to as a flat object. Examples of flat objects are tabletops, wall mirrors, door leaves, glass panes, solar panels. The expression “flat” refers to an object having a level surface without any protrusions or indentations from that surface.

The expression “protruding portion” as used herein means a portion that protrudes or projects from a main portion so that said projecting part is more exposed to damage and shocks than the main portion. Examples of a protruding portion are corners of flat objects, e.g. tabletop corners.

The expression “a shape corresponding to a shape of said protruding portion” as used herein means a shape arranged to be adapted to a shape of a protruding portion such that a protective material comprising the corresponding shape can be arranged around and tightly enclose the protruding portion (or projecting part) of an object to be protected by the protective material.

The expression “almost perpendicular to” as used herein includes an interval of accuracy familiar and acceptable to a person skilled in the art. Said interval is ±10 %.

The expression “a corner edge” as used herein refers to the edge that runs between two corners. For a flat object it is the edge running between two corners of the side wall.

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface active component, must be present to decrease surface tension. Finally, the foam must form more quickly than it breaks down. The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “dry cellulose foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam may be at least 95 wt % as calculated based on the total weight of the solid cellulose foam. The shape and density of the solid cellulose foam is retained also in a non-confined state. The solid cellulose foam has an open cell structure, allowing air to occupy the pores within the foam. The solid cellulose foam can also be described as a porous material or a low-density material.

The following detailed description, and the examples contained therein, are provided for the purpose of describing and illustrating certain embodiments of the invention only and are not intended to limit the scope of the invention in any way.

In a first aspect, the present invention relates to a solid cellulose foam product for protection of an object.

In a second aspect, the present invention provides a method of producing a solid cellulose foam product intended for protection of an object.

The first aspect of the present invention, i.e. the solid cellulose foam product for protection of an object, is now to be described in detail in the following and with reference to the figures.

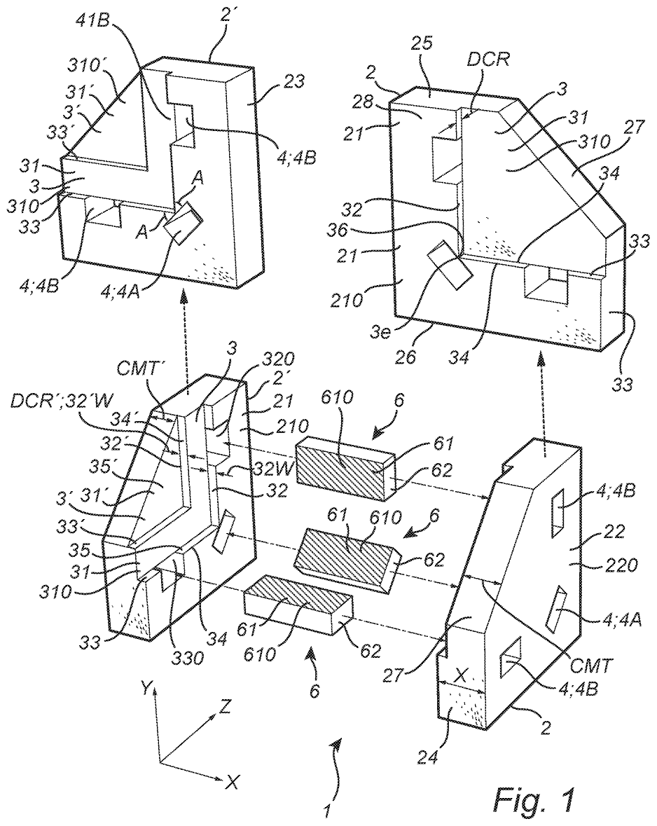

In FIG. 1 an exploded view of a preferred embodiment of the solid cellulose foam product 1 for protection of an object where the comprised components of said product 1 are shown. Said components are oriented in a X-, Y-, Z-plane in said FIG. 1.

Said solid cellulose foam product 1 comprises two base portions 2, 2′. Each base portion 2, 2′comprises an inside surface 21, an outside surface 22, a back surface 23, a front surface 24, an upper surface 25 and a lower surface 26.

An oblique surface 27 connects said upper surface 25 and said front surface 24.

Preferably, said inside surface 21 comprises a densified layer 210. More preferred, the outside surface 22 also comprises a densified layer 220. Most preferred, both of said inside and outside surfaces 21, 22 comprise densified layers 210, 220.

Said two base portions 2, 2′ are provided with a compressed region 3 comprising a compressed surface 31, a wall surface 32 and a bottom surface 33. Said compressed region 3 further has a first compression depth DCR (Depth of Compressed Region) which corresponds to a width 32W of said wall surface 32, and also to a width of said bottom surface 33.

As can be seen FIG. 1 said compressed region 3 is limited by the uncompressed region 28 and the oblique surface 27 of said base portion 3.

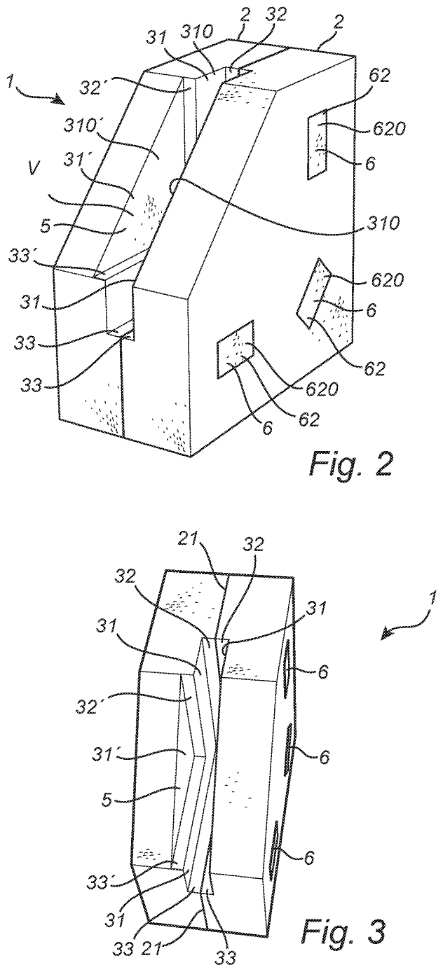

When housings (e.g. said compressed regions 3, 3′) of said two or more base portions are facing each other, a housing 5 is formed (best seen in FIGS. 2-3). It is to be noted here that each base portion comprises its own housing (e.g. said compressed regions 3, 3′), and that these housings (e.g. said compressed regions 3, 3′) when facing each other will form a housing 5. The term “housing” is thus used both for the housing on an individual base portion, and for the void formed by arranging two or more base portions such that the housings of the individual base portions are facing each other.

Each base portion 2, 2′ further comprises three holes 4A, 4B.

In FIG. 1, said holes are shown as through-going holes and will in the following therefore be referred to as through-going.

However, in some embodiments at least one of said holes may be a blind hole having an opening in said inside surface 21 and running from said inside surface 21 of said at least one base portion 2, 2′ and in a direction towards said outside surface 22 of said at least one base portion, but not all the way to said outside surface 22, i.e. not reaching said outside surface 22.

Said through-going holes 4A, 4B are arranged in a direction that is perpendicular or almost perpendicular to said inside surface 21 and said outside surface 22 of said base portions 2, 2′.

Said through-going holes 4A, 4B are further arranged in uncompressed regions 28 of said base portions 2, 2′.

In FIG. 1, it is shown that said through-going holes 4A, 4B arranged in uncompressed regions 28 are in a direct contact with said compressed region 3.

Two of said through-going holes, side holes 4B, are arranged in said direct contact with said compressed region 3 by a respective surface 41b of said side holes 4B such that said respective surface 41b form part of said wall surface 32 and said bottom surface 33 of said compressed region 3, respectively. An opening 320, 330 is thereby arranged in the respective said wall surface 32 and said bottom surface 33.

The third of said through-going holes is a corner hole 4A arranged at a corner edge 3e of a corner of said compressed region 3.

Said corner edge 3e of said compressed region 3 is formed by said wall surface 32 meeting said bottom surface 33. In the shown embodiment, said corner has a right angle.

Said through-going corner hole 4A is arranged to run from said inside surface 21 of the respective base portion 3, 3′ to said outer surface 22 of the respective base portion 3, 3′ and in a direction that is parallel to an edge 36 between said wall surface 32 of said compressed region 3 and said bottom surface 33 of said compressed region 3.

Preferably, said corner hole 4A is arranged at said corner edge 3e at an angle A to said wall surface 32 and said bottom surface 33. Said angle A is preferably in an interval of 30-60°, preferably 35-55°, and more preferred 40-50°. In FIG. 1 said angle A is about 45°.

In FIG. 1 there is further shown three plugs 6. In the shown embodiment, said plugs 6 have a rectangular shape corresponding to a rectangular shape of said through-going holes 4A, 4B.

Said plugs 6 comprises a respective contacting surface 61 arranged to contact said compressed region 3 when inserted into the respective through-going holes 4A, 4B.

Said contacting surface 61 preferably comprises a densified surface 610.

It is to be understood that shapes of said through-going holes may be other than rectangular shapes. However, said plugs may preferably have a shape corresponding to a shape of the through-going holes in order to fit into said holes.

Embodiments are further conceivable where one pair of a hole and a plug may be of one shape while another pair of plug and hole may have a different shape from the first pair without departing from the scope of the invention.

In preferred embodiment shown in FIG. 1, said base portions 2, 2′ differ somewhat from each other, i.e. they are not exactly mirroring each other, i.e. they are non-mirror halves, which difference is now to be described.

One of said base portions 2, 2′, namely base portion 2′ comprises not only one but two compressed regions 3, 3′.

A second compressed region 3′ is arranged on a portion of the compressed surface 31 of the compressed region 3. Said second compressed region 3′ has a second compression depth DCR′ that may be of a same value as the first compression depth DCR of said first compressed region or greater or smaller than said the first compression depth DCR. In relation to the uncompressed surface 28, a total depth from said surface 28 to a compressed surface 31′ of the second compressed region 3′ is the sum of the first compression depth DCR and said second compression depth DCR′.

Said second compressed region 3′ further comprises a wall surface 32′, a bottom surface 33′, and a width 32′W of said wall surface 32′ (and corresponding to said second compression depth DCR′). A width of said bottom surface 33′ corresponds to said second compression depth DCR′. Said second compressed region 3′ and said compressed surface 31′ are limited by said oblique surface 27 of said base portion 2′.

Said compressed surfaces 3, 3′ preferably comprise a densified layer 310, 310′.

By creating partial cuts and pressing to the different compression depths, it is possible to tailor said solid cellulose foam product around protruding portions of the object to be protected and eliminate the air transported. Thereby the overall size and cost of the packaged product are reduced. The compressed regions will also have an increased stiffness compared to the uncompressed regions, and will help keeping the object in place during e.g. transportation.

The cushioning properties of the solid cellulose foam further ensures that the object is protected.

FIGS. 2 and 3 show said solid cellulose foam product 1 in an assembled state.

Said two base portions 2, 2′ comprising said compressed regions 3, 3′ are fixedly arranged to each other by a fixing means. This is done by fitting said inside surfaces 21, 21′ to each other in a non-detachable manner.

In some embodiments said plugs 6 are said fixing means, or at least contribute to fixing said base portions 2, 2′ to each other.

Said fixing means may further comprise e.g. a glue, preferably a bio-based glue.

In some embodiments, the fixing means comprise both said plugs and a glue.

By fitting the inside surfaces 21 of each base portion 2, 2′ to each other, a void V is created and is defined by said compressed regions 3, 3′. Said void is referred to in the following as a housing 5.

Formulated differently, housings (said compressed regions 3, 3′) of said two or more base portions are facing each other thereby forming said housing 5.

By forming said housing 5 from two or more base portions 2, 2′ each comprising a housing (said compressed regions 3, 3′), the housing 5 (and thus also the protruding portion of the object to be protected), will be placed at the centre of the solid cellulose foam product 1 which provides good protection due to an optimal distribution of forces. In comparison, if only one base portion 2, 2′ were to comprise a housing, the protruding portion of the object to be protected would be placed only within that base portion 2, 2′ which in turn would reduce the protective properties of the product 1 since forces would be unevenly distributed during for example an impact.

Said housing 5 comprises bottom surfaces 33, 33′, compressed surfaces 31, 31′ and wall surfaces 32, 32′, where each of said surfaces comprised in the housing 5 together form a three-dimensional (3D) shape of said housing 5.

Said housing 5 is an open housing arranged to receive a protruding portion of an object to be protected and adapted to perfectly fit around a shape of said protruding portion, and preferably in a tight manner leaving no empty space between surfaces of said housing 5 and said protruding portion.

Said plugs 6 are arranged in said through-going holes 4 and only bottom/top surfaces 62 of said plugs are visible.

Preferably, said bottom and top surfaces 62 are aligned with said outside surfaces 22 of said base portions 2, 2′.

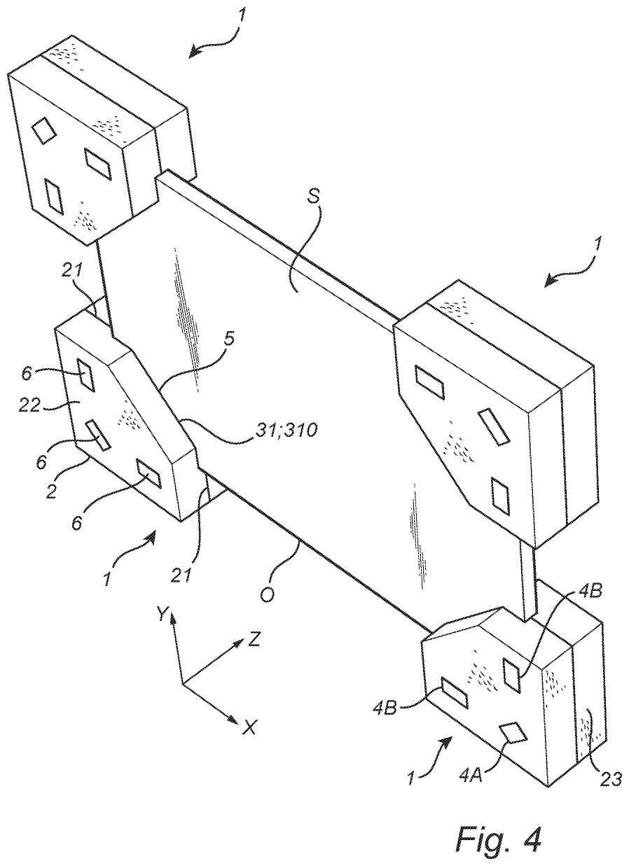

In a second preferred embodiment, and as shown in FIG. 4, the two base portions 2, 2′ are mirroring each other, i.e. they are mirror halves. Each of said two base portions comprise only one compressed region 3. Manufacturing is simplified when the two base portions 2, 2′ are mirroring each other.

FIG. 4 shows an object O comprising four protruding portions. Each of said four protruding portions is protected by the inventive solid cellulose foam product 1.

Said object O may preferably be a flat object O, e.g. a tabletop comprising four corners. To prevent the corners from breaking off or cracking during storage and transport, the inventive solid cellulose foam product 1, in a form of corner protectors, have been fitted to the corners. Said solid cellulose foam product 1 will absorb shocks in an excellent manner thanks to the aspects as defined in claim 1 and the dependent claims.

Said protruding portion are arranged in said housing 5 of said solid cellulose foam product 1; said housing has a shape corresponding to a shape of said protruding portion of said object.

The housing surrounding each protruding portion comprises two base portions 2, each base portion 2 comprising a respective compressed region 3. The voids of said compressed regions 3 together forming said housing 5.

It is conceivable that for more complex shapes of the protruding portion said solid cellulose foam product may comprise not only two but three or more base portions fixedly arranged to each other by a fixing means, and wherein the housings of said three or more base portions are facing each other thereby forming said housing having a shape corresponding to a shape of said protruding portion of said object.

Said holes 4A, 4B are arranged to be perpendicular to said protruding part of said flat object O. In FIG. 4 this is shown in that said flat object O extends in an x-/y-plane and said holes extend in a z-direction. Said holes extend in a direction perpendicular to a surface S of said flat object O.

At least one hole, corner hole 4A, is arranged at a corner portion of said protruding portion, preferably at a corner edge portion of said protruding portion.

Due to said housing 5 having a shape corresponding to the shape of the protruding portion, said corner edge 3e of said compressed region 3 of said housing corresponds to said corner edge portion of said protruding portion.

Said hole 4A is further arranged to have an angle (A) to said corner edge portion. Said angle (A) is in an interval of 30-60°, preferably 35-55°, and more preferred 40-50°.

Said two side holes 4B are arranged to be in a direct contact with said housing 5 (and thereby said protruding portion) by said openings 320, 330 shown in FIG. 1.

Since said holes 4A, 4B are arranged to be in a direct contact with said housing 5, said plugs arranged in said holes are in contact with the protruding portion of the object to be protected inside said housing at locations of the openings 320, 330.

Preferably, said plugs are arranged to contact said protruding portion by a respective surface comprising said densified layer.

Embodiments are conceivable where the holes 4 are arranged at a small distance, e.g. 0.5-10 mm, from said wall surface 32 and said bottom surface 33 of said compressed region 3. A region of uncompressed material 28 will then be present between said holes 4 and said compressed region 3. In these embodiments, said plugs will not be in a direct contact with said housing and thereby also not in a direct contact with said protruding portions.

Said corner hole 4A is preferably arranged adjacent to the edge line 36 between said bottom surface 33 and said wall surface 32 of said compressed region 3 and having said contacting surface 61 arranged perpendicular to said edge line 36, as earlier discussed. Said corner hole 4A may be arranged so close to said wall surface 32 and said bottom surface 33 that said edge line 36 may be removed through the arrangement.

However, embodiments are conceivable where there may be a small distance, e.g. 0.1-5 mm, between said contacting surface 61 and said edge line 36.

### MATERIALS AND MATERIAL PROPERTIES

Said solid cellulose foam product comprises:
at least one base portion 2, 2′ comprising at least one hole and at least one housing;
said at least one housing 5 of said at least one base portion is arranged to house a protruding portion of said object; and
at least one plug 6 arranged in said at least one hole 4 of said at least one base portion 2,2′.

A density of uncompressed regions 28 of said at least one base portion 2, 2′ is in the interval of 10-80 kg/m³, preferably 10-60 kg/m³, and more preferred 20-50 kg/m³.

A mean density of said at least one base portion 2, 2′ comprising uncompressed regions 28 and compressed regions 3, 3′ may preferably be in an interval of 10-80 kg/m³, preferably 20-55 kg/m³.

A density of said at least one compressed region 3, 3′ has is 110% or more of said density of said uncompressed region of said at least one base portion, preferably 120% or more, and more preferred 130% or more.

A density of said at least one plug 6 is higher than said density of said at least one uncompressed region of said at least one base portion.

Said density of said at least one plug 6 is 110% or more of the density of said at least one uncompressed region of said at least one base portion, preferably 120% or more, and more preferred 130% or more.

Preferably, said higher density of said plugs 6 has been reached through compressing said plugs to said higher density.

The at least one plug 6 will provide improved protection targeted to the protruding portion of the object to be protected. During a shock, the cushioning properties of the cellulose-based foam may not be sufficient to protect a protruding portion and the plugs then offer extra protection targeted to any protruding portions, such as a corner and/or an edge. By providing plugs having a higher density, the stiffness and resilience of the plugs are increased. This further improves the ability of the plugs to protect the protruding portion during a shock.

Said at least one base portion 2, 2′ comprises at least one surface comprising a densified layer.

Said at least one compressed region 3, 3′ of said at least one base portion 2, 2′ further comprises said densified layer.

Said at least one compressed region 3, 3′ of said at least one housing 5 comprises said densified layer.

Said at least one plug 6 comprises at least one surface comprising a densified layer. A surface comprising a densified layer is stiffer than a surface without a densified layer. It is therefore advantageous that the at least one plug 6 comprises a densified layer on at least one surface. This provides additional stiffness to the plug 6 which is important for sufficient protection of the protruding portion.

At least one surface of said at least one housing 5 is arranged to be in a direct contact with said protruding portion.

Said at least one surface of said at least one housing 5 arranged to be in said direct contact with said protruding portion comprises said densified layer.

A surface comprising a densified layer is stiffer than a surface without a densified layer. It is therefore advantageous that the at least one surface of said at least one housing 5 arranged to be in direct contact with said protruding portion comprises a densified layer, since that will help keeping the protruding portion in place in the housing 5.

Said at least one base portion 2, 2′ and said at least one plug 6 may preferably be prepared from a cellulose foam composition comprising:
a) from 71-95 wt % cellulose fibres, as calculated on the total weight of solid content of the composition,
b) from 4-24 wt % of a water-soluble thickener, as calculated on a total weight of solid content of the composition, and
c) at least two surfactants.

Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermos mechanical pulp (TMP) or chemo thermos mechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm.

The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

The cellulose fibres of the cellulose-based foam composition may be selected from wood pulp; regenerated cellulose fibres; and plant fibres, such as fibres from bamboo, cotton, hemp, flax, and jute.

Preferably, the cellulose fibres are selected from wood pulp, such as softwood pulp, hardwood pulp, chemical-thermomechanical pulp, and from dissolving pulp, or a combination of one or more of these.

More preferred, the cellulose pulp fibres are selected from softwood pulp, chemical-thermomechanical pulp, or dissolving pulp.

Most preferred, the cellulose pulp fibres are selected from softwood pulp, such as softwood kraft bleached pulp.

The water-soluble thickener may be present in an amount of from 4-24 wt %, or from 5-20 wt %, as calculated on the total weight of solid content of the foam. The thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof.

The foam preferably comprises a mixture of at least two surfactants. One of the at least two surfactants is preferably a fast-acting surfactant that during preparation of the foam quickly settle at the air-water interphase during mechanical agitation, which contributes to the formation of a foam with a high density and a high viscosity and thus enables a free-standing foam. A suitable surfactant for this purpose is an anionic surfactant, preferably a low-molecular weight anionic surfactant. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from high pKa fatty acids, such as from plant derived feedstock, e.g. tetradecanoic acid (myristic acid), sodium oleate, lauric acid, palmitic acid, and stearic acid; glucose based cosurfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. tween® (e.g. tween® 20, tween® 80 and tween® 85); and polyoxyethylene lauryl ethers, such as polyethylene glycol dodecyl ether, pentaethylene glycol monododecyl ether and octaethylene glycol monododecyl ether.

Said foam composition may preferably be prepared by a method comprising the steps of:
a) disintegrating cellulose fibres in water to obtain a slurry of cellulose fibres;
b) adding the thickener to the slurry obtained in a) to obtain a mixture of thickener and cellulose fibres in water;
c) adding the at least two surfactants to the mixture obtained in b) to obtain a fibre suspension;
d) aerating the suspension obtained in c) to obtain a wet foam, wherein the wet foam comprises 10-38 wt % cellulose fibres, 0.5-10 wt % of the water-soluble thickener, and 0.1-2 wt % surfactants, as calculated on the total weight of the wet foam, and wherein the wet foam has a density of from 140-500 kg/m³ and a yield stress of from 40 to 400 Pa;
e) drying the wet foam obtained in d) to obtain a dried cellulose foam.

The wet foam may be dried without using a mould, i.e. the wet foam is free-standing and retains its shape during drying without the need of a mould.

The wet foam is homogenous and has a good stability due to a small bubble size (typically below 100 μm) obtained when aerating the mixture of cellulose fibres, thickener and surfactants. The wet foam does not flocculate during processing. The average bubble size is largely maintained during any subsequent processing or drying steps and the cellulose fibres remain well dispersed. The resulting solid cellulose foam obtained by drying the wet foam will be homogenous in structure, strong, have good mechanical properties, a smooth surface and no defects. In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

Said dried cellulose foam obtained in step e) may be used as the solid cellulose foam material.

Said dried cellulose foam obtained in step e) may be obtained by a method comprising: depositing discrete units of a cellulose foam on a surface to obtain a first foam deposition, depositing a wet cellulose foam between the discrete units to obtain a subsequent foam deposition, and drying the wet foam to obtain a solid foam wherein discrete units of a foam are embedded in a foam matrix. Said solid cellulose foam may then be used as the solid cellulose foam of claim 1 and its dependent claims.

However, said solid cellulose foam may be prepared by other methods than the above described without departing from the scope of the present invention. For example, said solid cellulose foam may be prepared by a single deposition of a wet foam into any desired shape. Optionally, any suitable restriction means, such as a mould or a frame, may be used.

Said solid cellulose foam material may e.g. be prepared by depositing the foam composition on a forming portion of a conventional or, for the purpose suitably modified, paper machine for forming a foam web.

Said cellulose foam composition of said at least one base portion 2, 2′ and said at least one plug 6 may be identical or different.

Said solid cellulose foam is preferably not a memory foam going back to its original shape, rather said foam stays in its compressed shape. Said solid cellulose foam has an open-cell structure of a bulk of said foam. When compressed, the cellulose foam will be deformed and not able to recover its original shape.

An example of a conceivable dimension is a solid cellulose foam plank having a thickness in the range of from 1 to 20 cm, or from 1 to 10 cm, or from 1 to 5 cm, or from 4 to 6 cm. In one embodiment, the thickness is 50 mm. Said at least one base portion may be cut from such a plank and said thickness of the plank may preferably correspond to a width of said back surface 23 of said at least one base portion.

For embodiments where a higher density of the plugs is reached by compression, said plugs may e.g. be pressed to 40% of the thickness of the plank, i.e. a thickness of said compressed plugs is 20 mm.

Said dimensions only serve as examples and should not be seen as limiting the inventive product to said dimensions.

As earlier discussed, embodiments may be preferred where at least one surface of said at least one base portion 2, 2′, said at least one compressed region 3, 3′, said uncompressed region 28 and said at least one plug 6 comprises a densified layer.

Production of a solid cellulose foam comprises different production steps, one of which is a drying step. During said drying step outside surfaces of said foam (top surface, bottom surface, side surfaces) will get an outer layer that has different properties than a bulk portion of said foam comprising a more homogeneous open-cell porous fibre network. Said outer layer has a higher density than a density of said bulk portion because the fibres are packed more tightly and are partly oriented differently. The outer layer is called a “densified layer”. Said densified layer will provide improved mechanical stability and improved strength to the foam.

Thanks to said densified layer having improved mechanical stability and providing strength to said foam, it is preferred to orientate surfaces comprising said densified layer towards directions where extra shock absorption may be needed. The improved properties of said densified layer are used at positions of the product where they can contribute to the protective properties of said product.

Although having a higher density, said densified layer is still highly porous and air permeable. The densified layer has a negligible effect on the total density of the solid cellulose foam.

The second aspect of the present invention, i.e. method of producing a solid cellulose foam product intended for protection of an object, is now to be described in detail in the following and with reference to the figures.

Said method of producing a solid cellulose foam product comprises the steps of:
a) providing at least one base portion;
b) forming a housing in said at least one base portion arranged to house a protruding portion of an object;
c) providing said at least one base portion with at least one hole;
d) providing at least one plug arranged to be introduced to said at least one hole.

Preferably, said method further comprises:
Step b1) performing at least one cutting line of a predetermined depth of cut into at least one surface of said at least one base portion, whereby the at least one cutting line defining at least one pattern on said at least one surface, and preferably
step b2) pressing at least one pressing tool into said at least one pattern of said at least one surface of said at least one base portion thereby forming at least one compressed region of said base portion; said at least one compressed region forming a housing arranged to house a protruding portion of an object.

Step a) comprises providing at least one base portion 2, 2′.

Said base portion 2, 2′ may preferably have a rectangular or square shape to be easily fitted into a surrounding rectangular package.

Said base portion 2, 2′ further has thickness X that corresponds to a width of said back surface 23 and front surface 24.

In FIG. 1 said base portions 2, 2′ comprise an oblique surface 27.

Step b) forming a housing 5 in said at least one base portion 2, 2′ arranged to house a protruding portion of an object O.

Step b) further comprises step b1):
Providing at least one cutting line of a predetermined depth of cut into at least one surface 21 of said at least one base portion 2, 2′, whereby the at least one cutting line defines at least one pattern on said at least one surface 21.

At parts where the at least one cutting line is to be provided, said at least one base portion 2, 2′ has a thickness X; said thickness X is in an interval of 2-20 cm, preferably 3-10 cm, and most preferred 4-6 cm.

A cutting tool (not shown), e.g. a knife or a cutting blade or some other kind of relevant and sharp-edged cutting tool, is preferably arranged at a starting position near the at least one surface 21 intended to be cut into.

After having positioned the cutting tool in the proper starting position, the cutting tool is caused to be moved in a direction towards the at least one surface 21. The movement causes the cutting tool to come into a direct contact with said at least one surface 21 and the movement of the cutting tool continues such that the cutting tool begins to cut into and through the surface/-s 21 and into a core of said at least one base portion 2, 2′.

Said at least one cutting line is arranged to partially cut through said thickness X of said at least one base portion 2, 2′ to a predetermined depth of cut such that predetermined depth of cut is less than said thickness X of said at least one base portion 2, 2′.

The movement of the cutting tool (and the cutting operation) into said at least one base portion 2, 2′ continues until said predetermined depth of cut is reached. The cutting tool is then removed from the at least one base portion 2, 2′ leaving a cutting line in said at least one base portion 2, 2′.

Said predetermined depth of cut of said at least one cutting line is preferably 90% or less of said thickness X of said cellulose foam material 1, more preferred 70% or less and most preferred 60% or less.

In some embodiments, said cutting tool comprises two or more knives or blades. When using a cutting tool with two or more knives or blades, two or more patterns may be instantly cut in one and the same cutting operation, i.e. in one step. It is further conceivable that the two or more knives or blades perform cutting lines of different depth of cut.

There is also conceivable to use a cutting tool having only one knife or blade and to use two or more cutting tools of variable shape and depth of cut and repeating step b1) for every cutting tool.

Repetition of step b1), providing the at least one cutting line, may be performed before step b2), the pressing step, or be alternated with pressing step b2).

In some embodiments, the cutting tool may in its simplest form have a linear shape providing a linear cut.

In other embodiments, the cutting tool may be of a more complex shape and provide a curved cut and/or a cut formed as a closed loop.

Said at least one cutting line arranged on at least one surface 21 of said at least one base portion 2, 2′ defines at least one pattern on said at least one surface 21 of said at least one base portion 2, 2′.

In the embodiment shown in FIG. 1, a surface of said at least one pattern is defined by at least one cutting line and at least one edge of said at least one base portion 2, 2′.

In other embodiments said surface of said at least one pattern may be defined by at least one linear cutting line and at least one curved cutting line.

Step b1) of the method is followed by a pressing step, step b2).

Step b2) comprises pressing at least one pressing tool into said at least one pattern of said at least one surface of said at least one base portion thereby forming at least one compressed region 3, 3′ of said base portion; said at least one compressed region 3, 3′ forming a housing 5 arranged to house a protruding portion of an object O.

The pressing step b2) preferably starts with positioning said at least one pressing tool to a starting position near said at least one pattern followed by causing said at least one pressing tool to move towards said pattern of said at least one surface 21 such that the at least one pressing tool contacts said surface of said pattern and exerts a pressure on said surface of said pattern thereby compressing said material of a portion of said at least one base portion 2, 2′.

Said pressure exerted by said at least one pressing area of said at least one pressing tool causes said at least one pattern to be compressed in a direction coinciding with a direction of said pressing, and further into a core of the at least one base portion 2, 2′.

Said pressing tool is removed after having reached a predetermined depth of compression by said pressing.

In FIG. 1, it is shown that the at least one compression has been performed in a direction from the said inside surface 21 and perpendicular towards said outside surface 22; and parallel or almost parallel to the front surface 24 and back surface 23 of said at least one base portion 2, 2′.

After having completed said at least one pressing step, at least one compressed region 3, 3′ has been formed in said at least one base portion 2, 2′.

Said at least one pressing tool may preferably have at least one pressing area that corresponds to or is smaller than said area/said surface of the at least one pattern of said at least one surface 21.

In some embodiments, said at least one pressing area may comprise an edge line surrounding said at least one pressing area and said pressing edge line may preferably be arranged to coincide with said at least one cutting line during the pressing step.

Said edge line may preferably be a right-angled edge line.

For items of a more complex shape said at least one pressing tool may have more than one pressing area. Said pressing areas may be of different sizes.

Each pressing area may in some embodiments have a respective pressing edge line that is right-angled.

However, embodiments are conceivable where at least one of the pressing areas may have a curved edge line.

Said pressing areas of different sizes may also be of different shapes and arranged to penetrate and compress said at least one surface 21 to different pressing depths.

Thicknesses of said pressing tool corresponding to said different pressing depths.

In some embodiments, said pressing direction may be performed not parallel to but at an angle to said front surface 24 and said back surface 23 of the at least one base portion 2, 2′. In these embodiments it may be preferred that also the at least one cutting line has the same angle as the pressing direction.

In some embodiments of the invention, step b1) and step b2) are performed simultaneously. The cutting tool and the pressing tool are one and the same tool, i.e. a combined tool performing both a cutting operation and pressing operation.

Said combined tool preferably comprises at least one sharp edge for providing said cutting and at least one pressing area for performing the compressing of said at least one base portion 2, 2′.

In embodiments where said combined tool is used and step b1) and step b2) are performed simultaneously into a combined step, it is conceivable to perform said combined step not only once but to repeat said combined step two or more times.

Irrespective of performing cutting and pressing as separate steps or as a combined step, said at least one base portion 2, 2′ now comprises at least one compressed region 3, 3′ and at least one uncompressed region 28.

Said at least one compressed region 3, 3′ comprises a compressed solid cellulose foam having a compressed thickness CMT, CMT′, said compressed region 3, 3′ further having a volume.

In some embodiments, said pressing step is performed until a pressing depth equal to the predetermined depth of cut.

In other embodiments, said pressing depth PD may be less than or greater than said predetermined depth of cut DC.

Said compressed thickness CMT, CMT′ may be calculated as the thickness X of the uncompressed region 28 of said at least one base portion 2, 2′ at the position for the at least one cutting line minus the depth of the compressed region, DCR, DCR′:

CTM=X−DCR

CTM′=X−(DCR+DCR′)

The said at least one base portion 2, 2′ provided in step a) preferably has a uniform bulk density, and preferably also at least one densified layer. Pressing said at least one pressing tool into said at least one pattern of said at least one base portion 2, 2′ results in a higher density of said solid cellulose foam comprised in said at least one compressed region 12 than the density of the provided—and uncompressed—said solid said at least one base portion 2, 2′.

Said density of the at least one compressed region 3, 3′ is 110% or more of said density of said uncompressed region of said at least one base portion, preferably 120% or more, and more preferred 130% or more.

Embodiments are conceivable where the pressing tool is the object O to be protected, i.e. when inserting said protruding portion of said object, a pressure is exerted by the object such that the object itself compresses the foam and creates the housing 5.

In other embodiments said pressing tool only partly causes the compression and the remaining compression is made by inserting said object O.

As shown in FIGS. 1-3, one of the base portions 3, 3′, namely base portion 3′, has two compressed regions 3, 3′. Two or more compressed regions may be created by either repetition of step b1), providing the at least one cutting line, may be performed before step b2), the pressing step, or be alternated with pressing step b2).

Step c) comprises providing said at least one base portion with at least one hole.

Said at least one hole 4 may be a through-going hole or a blind hole. Embodiments comprising two or more holes 4 may comprise a mix of through-going holes and blind holes.

In the Figs. said at least one hole 4 is a through-going hole having a rectangular shaped cross-sectional area but other shapes are conceivable, e.g. square, triangular, cylindrical, star-shaped or other conceivable shapes without departing from the scope of the invention.

In some embodiments said corner hole 4A may have a form of an L arranged to surround said corner edge 3e of said compressed region 3, and, hence, the corner of said protruding portion.

Preferably, said at least one hole 4 is arranged from said inside surface 21 of the uncompressed region 28 and towards said outside surface 22 of said at least one base portion 2, 2′. In embodiments as shown in the Figs., said hole 4 runs to said surface 22 and forms an opening in said surface 22.

In embodiments wherein said at least one hole 4 is a blind hole, said blind hole has an ending inside of said at least one base portion 2, 2′ and does not reach said outside surface 22.

Said at least one hole 4 may be provided by a cutting tool.

Said at least one hole is arranged at positions of said at least one base portion 2, 2′ as already disclosed in relation to the first aspect of the invention.

Step c) comprises providing at least one plug arranged to be introduced to said at least one hole.

Said at least one plug 6 may be manufactured as a rod that is cut into pieces of plugs of appropriate length. Every mantle surface of said at least one plug 6 will have a dense layer. However, the surfaces of the cuts will not have said dense layer.

Said plug 6 may be individually manufactured. All sides of the plug 6 will then have a dense layer.

Said at least one plug 6 has a density higher than a density of said uncompressed region 28 of said at least one base portion 2, 2′. A thickness of said densified layer is so small, i.e. said densified layer is so thin, that the higher density of said densified layer does not have an impact on the density of said at least one plug 6.

Said density/mean density of said at least one plug 6 is higher than a mean density of said at least one base portion 2, 2′ comprising said compressed region 3, 3′, and preferably also at least one densified layer.

It is to be pointed out that said densified layer is so thin that a density of said densified layer does have only a very small impact on the mean densities of the respective plugs and base portions as compared to mean densities of the respective plugs and base portions in embodiments without any densified layer. Said densified layer is like a thin skin on the surfaces.

Said density of said at least one plug 6 is 110% or more of the density of said uncompressed region 28 of said at least one base portion, preferably 120% or more, and more preferred 130% or more.

Said higher density of said at least one plug may be obtained by compressing said at least one plug 6.

Said compression of said at least one plug 6 is at least 10% of a thickness before said compression and as measured in a direction of compression, more preferred 20% and most preferred 30%.

Preferably, said at least one plug 6 has a shape complementary to a shape of said at least one hole 4 into which hole 4 said plug 6 is to be inserted.

In embodiments wherein said corner hole 4A is L-shaped, said plug 6 intended to be arranged in said corner hole 4A will have a corresponding L-shape.

In embodiments wherein said at least one plug 6 has only one mantle surface comprising said densified layer, this said mantle surface comprising said densified layer is said contacting surface 61 arranged to contact said protruding portion of said object O to be protected.

In embodiments where said solid cellulose product comprises two or more base portions 2, 2′, said method further comprises a step of arranging said two or more base portions 2, 2′ to be firmly fixedly to each other by a fixing means; the respective housings 5 of said two or more base portion 2, 2′ are facing each other thereby forming said housing 5 arranged to house a protruding portion of an object O.

It is to be understood that it is the void V of said at least one compressed region 3, 3′ of each base portion that forms said housing of each base portion. A volume of said formed housing 5 is a sum of the volumes of said voids V.

In some embodiments of the invention, said solid cellulose foam product comprises only one base portion 2. Said housing may be provided in said one base portion by cutting out a certain volume of cellulose foam of said one base portion thereby creating said housing 5.

In yet other embodiments of the invention, said solid cellulose foam product comprises three or more base portions fixedly arranged to each other, and wherein the compressed regions/housings of said two or more base portions are facing each other thereby forming a shape corresponding to a shape of said protruding portion of said object.

As will be understood by those skilled in the present field of art, numerous changes and modifications may be made to the above described and other embodiments of the present invention, without departing from the scope of the present invention as defined in the appending claims.

For example, embodiments are conceivable having no oblique surface connecting said upper surface and said front surface. Instead, said upper surface meets said front surface, preferably in a perpendicular contact.

It should be noted that the above described aspects may be the subject for its own protection, as such in a separate divisional application. Hence, it is foreseen that this aspect of the invention may require a protection by its own, e.g. since it may be applicable per se also in other concepts than that defined by the independent claim in this application.

### EXAMPLES

### Example 1

Solid cellulose foam products for protection of the corners and edges of a flat object were prepared from a solid cellulose foam plank having a thickness of 5 cm. The cellulose foam was dry, had a density in the range of from 32 to 35 kg/m³ and comprised from 83 to 88 wt % cellulose fibres (softwood bleached Kraft pulp), from 10 to 15 wt % thickener (CMC) and about 2 wt % surfactant (mixture of myristic acid and sodium cocoyl sarcosinate). The foam plank had densified layers on the top and bottom side. The corner protection products were formed by cutting the foam plank into two base portions corresponding to those shown in FIG. 1. A cutting table was used for cutting. Densified layers were present on the top and bottom surface also after cutting, i.e. the base portions had the same thickness as the foam plank. Three through-going holes were formed in each base portion by cutting. The housing was formed by pre-cutting a pattern corresponding to the housing followed by pressing. Three plugs were formed by cutting and compressing the foam plank into plugs having a densified layer present on two surfaces. The thickness of the plugs before compression was 5 cm, after compression it was 2 cm.

The corner protection product was assembled by attaching the two base portions to each other with glue. The plugs were inserted in the holes, the plugs were arranged so that the densified layers faced the housing. The assembled corner protection product is similar to that shown in FIGS. 2 and 3.

To test the protective properties of the corner protection product, a corner of a flat tabletop was inserted into the housing of the corner protection product. A drop test was performed, where the tabletop was dropped on the corner protected by the corner protection product. After the drop, the tabletop was inspected for any damage.

It was found that the corner protection product was able to protect the corner of the tabletop.

### Example 2—Comparative

In a comparative example, a cellulose foam plank was cut into two base portions as described for example 1, but without forming any holes and without any plugs.

The corner protection product was assembled by attaching the two base portions to each other with glue. The protective properties were tested as described for example 1. It was found that the corner protection product was split in two halves upon impact and was thus not able to protect the tabletop.

1. A solid cellulose foam product for protection of an object said solid cellulose foam product comprising:
at least one base portion comprising at least one hole and at least one housing;
said at least one housing of said at least one base portion configured to house a protruding portion of said object; and
at least one plug arranged in said at least one hole of said at least one base portion.

2. The solid cellulose foam product according to claim 1, wherein said at least one housing has a shape corresponding to a shape of said protruding portion of said object.

3. The solid cellulose foam product according to claim 1, wherein said at least one hole is arranged to be perpendicular to said protruding portion of said object when said object is arranged in said at least one housing.

4. The solid cellulose foam product according to claim 1, wherein said at least one hole is arranged at a corner portion of said protruding portion.

5. The solid cellulose foam product according to claim 4, wherein said at least one hole is arranged at a corner edge portion of said corner portion and is further arranged to have an angle to said corner edge portion.

6. The solid cellulose foam product according to claim 5, wherein said angle is between 30-60°.

7. The solid cellulose foam product according to claim 1, wherein said at least one hole is arranged to be in a direct contact with said housing.

8. (canceled)

9. (canceled)

10. The solid cellulose foam product according to claim 1, wherein said solid cellulose foam product comprises two or more base portions fixedly arranged to each other by a fixing means, and
wherein housings of said two or more base portions face each other thereby forming said housing having a shape corresponding to a shape of said protruding portion of said object.

11. The solid cellulose foam product according claim 10, wherein said fixing means comprises said at least one plug.

12. The solid cellulose foam product according to claim 1, wherein said at least one plug has a shape complementary to a shape of said at least one hole.

13. The solid cellulose foam product according to claim 1, wherein said at least one base portion comprises at least one compressed region of a higher density than an uncompressed region of said at least one base portion

14. (canceled)

15. (canceled)

16. (canceled)

17. The solid cellulose foam product according to claim 1, wherein a density of said at least one plug is higher than a density of said at least one base portion.

18. The solid cellulose foam product according to claim 1, wherein a density of said at least one plug is 110% or more of a density of said at least one base portion.

19. The solid cellulose foam product according to claim 1, wherein said at least one base portion comprises at least one surface comprising a densified layer.

20. (canceled)

21. (canceled)

22. The solid cellulose foam product according to claim 19, wherein said at least one plug comprises at least one surface comprising a densified layer.

23. The solid cellulose foam product according to claim 1, wherein at least one surface of said at least one housing is arranged to be in a direct contact with said protruding portion.

24. (canceled)

25. The solid cellulose foam product according to claim 1, wherein said at least one plug arranged in said at least one hole is further arranged to be in a direct contact with said protruding portion inside said housing.

26. (canceled)

27. The solid cellulose foam product according to claim 1, wherein said at least one base portion and said at least one plug each comprise a cellulose foam composition comprising:
a) from 71-95 wt % cellulose fibres, as calculated on a total weight of solid content of the cellulose foam composition;
b) from 4-24 wt % of a water-soluble thickener, as calculated on the total weight of solid content of the cellulose foam composition, and
c) at least two surfactants.

28. (canceled)

29. (canceled)

30. A method of producing a solid cellulose foam product, the method comprising the steps of:
a) providing at least one base portion;
b) forming a housing in said at least one base portion arranged to house a protruding portion of an object;
c) providing said at least one base portion with at least one hole; and,
d) providing at least one plug arranged to be introduced to said at least one hole.

31. The method of claim 30, wherein said forming further comprises:
b1) performing at least one cutting line of a predetermined depth of cut into at least one surface of said at least one base portion, whereby the at least one cutting line defines at least one pattern on said at least one surface, and optionally,
b2) pressing at least one pressing tool into said at least one pattern of said at least one surface of said at least one base portion thereby forming at least one compressed region of said base portion,
said at least one compressed region arranged to house the protruding portion of the object.

32. The method according to claim 30, further comprising:
arranging two or more base portions to be firmly fixed to each other by a fixing means; respective housings of said two or more base portions facing each other thereby forming said housing arranged to house the protruding portion of the object.

33. The method according to claim 30, wherein said at least one plug has a density higher than a density of said at least one base portion.

34. (canceled)

35. (canceled)

36. (canceled)

37. (canceled)

38. The method according to claim 30, wherein said at least one base portion or said at least one plug, or both comprise at least one surface comprising a densified layer, and wherein the method further comprising:
arranging said densified layer to be in a direct contact with said protruding portion.
